(19) United States
(12) Patent Application Publication
(10) Pub. No.: US 2026/0132886 A1
(43) Pub. Date: May 14, 2026

(54) SHOE RACK

(71) Applicant: Gray Raven Studio, LLC, Sterling Hts, MI (US)

(72) Inventor: Edward Birtulescu, Sterling Hts, MI (US)

(73) Assignee: Gray Raven Studio, LLC, Sterling Hts, MI (US)

(21) Appl. No.: 19/384,141

(22) Filed: Nov. 10, 2025

Related U.S. Application Data
(60) Provisional application No. 63/719,405, filed on Nov. 12, 2024.

(51) Int. Cl. F16M 13/02; A47F 7/08

(52) U.S. Cl. CPC F16M 13/02; A47F 7/08

(57) ABSTRACT

A shoe rack that is capable of being attached to a wall or surface. The shoe rack generally comprises a base, wherein the base has a slot or orifice through a surface thereof. The shoe rack has a first arm extending from a first end of the base and a second arm extending from a second end of the base. The shoe rack also includes a bottom member arranged at a bottom end of the first arm and the bottom end of the second arm. A single shoe is placed in the shoe rack. The shoe rack for the present invention may have a plurality of the shoe racks arranged on a wall in any known pattern or design.

### BACKGROUND OF THE INVENTION

### 1. Field of the Invention

The present invention generally relates to a shoe rack and more particularly relates to a shoe rack that is attached to a wall or other surface and can be used to display shoes as art.

### 2. Description of Related Art

Shoe racks and shoe storage devices are well known in the art. Generally, shoe racks are racks that are placed on the floor and allow for the storage of shoes in a neat manner. Other types of prior art shoe storage include shelves or floor space in a closet, wherein the shoes are placed next to each other on a shelf or on the floor of a closet when not being worn by the user of the shoe. The prior art also has shoe storage bags or racks that attach to a door, such as the backside of a door of a room or a closet, which allow for shoes to be held in pouches hung from a door frame or from arms extending from a metal or plastic frame, wherein the shoe is placed over the flange such that the sole of the shoe is shown to the user of the shoe. Many in the prior art buy shoes as an investment and collect shoes, such as sneakers, high heels or any other type of shoe. Many consumers who collect shoes collect sneakers and may buy new versions of an Air Jordan, Puma or any other sneaker brand when a special commemorative shoe is sold.

Collectors buy sneakers and other shoes at a very high rate, hence, there is a need in the art for a methodology and apparatus of storing the shoes on a shoe rack, which also may increase the value of the shoes through the storage method of the shoes. Furthermore, there is a need in the art for a shoe rack that is capable of being attached to a wall in order to display the shoes for viewing by others without having to go into the closet of the owner of the shoes. The ability to take one's shoe collection in the form of sneakers and turn those sneakers, which are prized by the collector of the shoes, into an art display which is attached to a wall or to any other flat, vertical or horizontal surface would allow for an increase in the value of the sneaker collection via the ability to display such sneaker collection for viewing by the general public or friends of the shoe collector. There also is a need in the art for a shoe rack that may be attached to a wall to be capable of holding a high heel shoe, wherein the high heel shoe rack allows the owner of the high heel shoes to display the shoes in any configuration. Therefore, the shoe racks may be attached to a wall via any known fastener and arranged in any known shape, such as a heart shape, a star shape, random shape developed by the shoe collector, etc.

Therefore, there is a need in the art for an improved shoe rack. There also is a need in the art for an improved shoe rack that is capable of being attached to a surface or a wall for displaying and storage of a sneaker or high heel or any type of shoe. There also is a need in the art for a shoe rack that may be arranged in any known manner to create an art exhibit of a shoe being stored and displayed in a shoe rack cluster. There also is a need in the art for an improved shoe rack that is capable of holding a sneaker or a high heel for display of either type of shoe on a wall of any known structure. There also is a need in the art for a shoe rack that is low cost, easy to manufacture and easy to install on the wall of a room wherein the shoes may be displayed. There also is a need in the art for a shoe rack that may hold a single sneaker or high heel in the shoe rack for display purposes or as an art display arranged on the wall of the shoe collector. There also is a need in the art for a shoe rack that may be attached to a wall that may hold both a left and right shoe in the shoe rack, thus allowing for the display of a shoe collection on a wall as art, wherein the shoes are arranged in pairs instead of as a single shoe.

### SUMMARY OF THE INVENTION

One object of the present invention may be to provide a novel and unique shoe rack.

Another object of the present invention may be to provide a novel and unique shoe rack that is capable of being attached or connected to a wall for displaying of a shoe.

Still another object of the present invention may be to provide a shoe rack that is capable of taking a shoe collection and turning it into art, therefore increasing the value of the shoe collection by displaying the shoes on a wall in any pattern desired by the shoe collector.

Yet another object of the present invention may be to provide a shoe rack that is capable of displaying and storing sneaker type shoes on a wall of a room.

Still another object of the present invention may be to provide a shoe rack that is capable of storing and displaying high heel shoes on a wall or surface of a room.

Yet another object of the present invention may be to provide a shoe rack that is low in cost and easy to manufacture.

Still another object of the present invention may be to provide a shoe rack that is made of moldable plastic material and may be molded in a variety of colors depending on the design requirements of the shoe collector buying the shoe rack.

Yet another object of the present invention may be to provide a shoe rack that is capable of displaying shoes on a wall or surface of a room in a building that is easy to install.

According to the present invention, the foregoing and other objects and advantages are obtained by a novel design for a shoe rack. The shoe rack is capable of being attached to a wall or a surface, wherein the wall or surface is generally vertical in nature, however it is also contemplated that any angled wall or horizontal surface may also be used to attach the shoe rack thereto. The shoe rack generally comprises a base, wherein the base has a slit/slot or orifice through a surface thereof and that orifice or slit is used to attach the base of the shoe rack to a wall or other surface in the room of a building. Any known fastener is passed through the orifice and into the wall in a predetermined manner in order to secure the shoe rack to the wall in a predetermined position. The shoe rack has a first arm extending from a first end of the base of a shoe rack at a first predetermined angle and then the first arm includes a second predetermined angled portion extending from the first portion. The shoe rack also includes a second arm arranged from a second end of the base, wherein the second arm has a first portion extending at a first predetermined angle from the base and then a second portion extending at a second predetermined angle from the first portion of the second arm. The first arm and the second arm of the shoe rack are connected at a bottom portion of the shoe rack and forms a singular piece, wherein the bottom portion of the shoe rack generally includes a curve therein that may be capable of receiving the back end of the shoe therein. The bottom portion of the shoe rack may also include a flange or lip arranged at a back bottom portion thereof, wherein the lip may be used to engage with the bottom rear heel of the shoe being stored in the shoe rack, such that the bottom portion of the shoe may not slip through the shoe rack and fall from the shoe rack, which is connected to a wall during use thereof. Hence, a single shoe is placed into the shoe rack of the present invention wherein the bottom portion of the heel of the shoe is engaged with the heel flange of the shoe rack and with a surface of the base near the toe portion of the sole of the shoe. It should be noted that the shoe rack of the present invention may be arranged on a wall in any known pattern or any desired pattern by the shoe collector. These patterns may include but are not limited to star configurations, circular configurations, triangular configurations, square configurations, heart shaped configurations, etc. Therefore, any type of configuration of the shoe racks may be arranged on the wall, such that the shoes owned by the shoe collector may be displayed for viewing by the public or others who enter the room where the shoe rack or a plurality of shoe racks are attached to the wall in a predetermined design.

One advantage of the present invention may be that it provides a novel and unique shoe rack.

Another advantage of the present invention may be that it provides a novel and unique shoe rack that is capable of being connected to a wall in any manner and in any predetermined pattern or shape such that a plurality of shoes may be displayed for viewing by the public.

Still another advantage of the present invention may be that it provides a shoe rack that is capable of displaying a shoe collector's shoe collection in an art display by attaching the shoe racks to a wall or other surface in a predetermined pattern to display the shoes, thus increasing the value of the shoes as they are used as art when not being worn by the user of the shoes.

Yet another advantage of the present invention may be to provide a shoe rack that is capable of displaying and storing a single sneaker within the shoe rack.

Still another advantage of the present invention may be to provide a shoe rack that is capable of storing or displaying one high heel shoe in the shoe rack that is attached to a wall or other surface of a room.

Yet another advantage of the present invention may be to provide a shoe rack that is low in cost and easy to manufacture.

Still another advantage of the present invention may be to provide a shoe rack that is made of a moldable plastic that is capable of being molded in a variety of colors depending on the design requirements of the shoe collector using the shoe rack for displaying of their collection.

Still another advantage of the present invention may be to provide a shoe rack that is easy to install on a wall or surface of a room in a building and is capable of being installed with other shoe racks such that a plurality of shoe racks may be used to form predetermined designs or shapes on a wall thus allowing creative license to the shoe collector in how the shoe collection is displayed and shown to the public.

Other objects, features and advantages of the present invention will become apparent from the subsequent description, and appended claims taken in conjunction with the accompanying drawings.

### BRIEF DESCRIPTION OF THE DRAWINGS:

FIG. 1 shows a perspective view of a shoe rack according to the present invention.

FIG. 2 shows a rear view of a shoe rack according to the present invention.

FIG. 3 shows a bottom view of a shoe rack according to the present invention.

FIG. 4 shows a front view of a shoe rack according to the present invention.

FIG. 5 shows a left side view of a shoe rack according to the present invention.

FIG. 6 shows a right side view of a shoe rack according to the present invention.

FIG. 7 shows a top view of a shoe rack according to the present invention.

FIG. 8 shows a perspective view of a shoe rack on a wall with a sneaker arranged thereon according to the present invention.

FIG. 9 shows an alternate embodiment of a shoe rack according to the present invention.

FIG. 10 shows a rear view of the alternative embodiment of the shoe rack according to the present invention.

FIG. 11 shows a bottom view of the alternate embodiment of a shoe rack according to the present invention.

FIG. 12 shows a front view of an alternate embodiment of the shoe rack according to the present invention.

FIG. 13 shows a left side view of an alternate embodiment of the shoe rack according to the present invention.

FIG. 14 shows a right side view of an alternate embodiment of the shoe rack according to the present invention.

FIG. 15 shows a top view of the alternate embodiment of the shoe rack according to the present invention.

FIG. 16 shows a perspective view of the alternate embodiment of the shoe rack with a high heel shoe arranged therein according to the present invention.

### DESCRIPTION OF THE EMBODIMENT(S)

Referring to the drawings, a shoe rack 20 that is capable of being attached to a wall or any other surface 22 of a room or building is shown according to the present invention. It should be noted that the shoe rack 20 may be used on any wall, surface, floor or display, wherein the wall 22 may be vertical, set at an angle, horizontal, or it may be connected to other displays or holders depending on the design requirements and the nature of the display of the shoes 24 arranged therein. The shoe rack 20 of the present invention may be capable of being attached to a wall 22 of a room in order to store the shoes 24 in a predetermined position while also displaying that shoe 24 as a work of art. It should be noted that multiple shoe racks 20 according to the present invention may be arranged in a predetermined pattern or shape, thus allowing for the shoe collector to have the shoe collection displayed as art on a wall 22 or other surface in a room of any known building for the public to view, thus increasing the value of the shoes as the displaying of the shoes that are viewable by the public may increase the good will associated with the shoe and the predisposition of the public to buy the shoe, thus increasing the value of the shoe to the shoe collector. It should be noted that the shoe rack 20 is generally connected or secured to a wall 22 via a fastener 26. However, it is also contemplated to use multiple fasteners 26 to secure the shoe rack 20 to the wall 22 or surface where the shoe 24 may be displayed and stored. It should be noted that the wall 22 where the shoe racks 20 may be attached thereto may be walls 22 in any known room of a building, such as a closet, a bathroom, a front room, a hallway, an art wall, a bedroom, a living room, or a family room, or any other known room or any known commercial store, such as a shoe store, a department store, and even in art museums or other areas where art displays are used, such as but not limited to, the outside walls of stores, etc. Therefore, the shoe rack 20 of the present invention is used to store and display a shoe 24 and creates an art piece incorporating the shoe 24 or having that shoe 24 displayed in any predetermined manner or design thus increasing the value of the shoe 24 by creating excitement and wonder about the shoe 24 via the displaying of the shoe 24 in such a manner that the shoe 24 becomes art when displayed in the shoe rack 20 of the present invention. The buzz or word of mouth that is created by having a shoe 24 arranged and held within the shoe rack 20 as an art piece may increase the value of the shoe 24 to the collector of the shoes via many more people wanting the shoes in the shoe collection, which is displayed as art on the wall of the room in any known building. It should be noted that the shoe racks 20 shown in the drawings of the present invention are generally a single shoe rack 20. Hence, only one shoe 24 may be displayed in the shoe rack 20 at a time. Therefore, either one sneaker or other man type shoe or one high heel or other women type shoe may be displayed in the shoe racks 20 disclosed and shown in the drawings therein. However, it is also contemplated that a shoe rack 20 that includes a first and second shoe holder, such that a left and right shoe forming a pair, may be displayed side by side is also contemplated. It is also contemplated that a multi shoe rack capable of holding multiple shoes of the same design or different designs may also be used to create specific designs for the holding and displaying of specific shoe brands, etc.

One contemplated embodiment of the shoe rack 20 of the present invention generally may include a base 30. Generally, the base 30 is a portion of the shoe rack 20 that may be attached to the wall 22 or surface of the room. The center portion of the base 30 may generally have an orifice or slot 32 arranged through a surface thereof. This orifice 32 may allow for a fastener 26 to be passed through the orifice 32 in order to have the fastener 26 engage with the wall 22 or surface upon which the shoe rack 20 is to be connected. It should be noted that it is contemplated that a single fastener 26 may be used to hold the shoe rack 20 to the wall 22, however multiple fasteners 26 may also be used and placed through the slot 32 to secure the shoe rack 20 to a wall 22. It should also be noted that any known mechanical or chemical fastening technique or methodology may be used to secure the shoe rack 20 to a wall 22, such as but not limited to adhesives, nails, books, etc. It should further be noted that the slot 32 may also include a flange 34 extending from a back surface of the base 30 such that the flange 34 may also engage with or contact the wall 22 when the shoe rack 20 is arranged thereon. The base 30 may have a first angled surface on one side thereof and a second angled surface on a second side thereof, such that a gap exists between the midpoint of the base 30 and the wall 22 to which it is attached. Hence, a flange 34 extends from the backside of the base 30 along the center length of the orifice 32 where the orifice 32 or slot is arranged in order to contact the wall 22. The first angled surface and second angled surface of the base 30 also contacts the wall 22 when the shoe rack 20 is attached to the wall 22. It should be noted that the base 30 and arms 40, 50 may have a uniform thickness throughout the entire shoe rack 20. Therefore, during molding of the shoe rack 20 the same thickness may allow for proper hardening and drying of the moldable plastic material after leaving the mold.

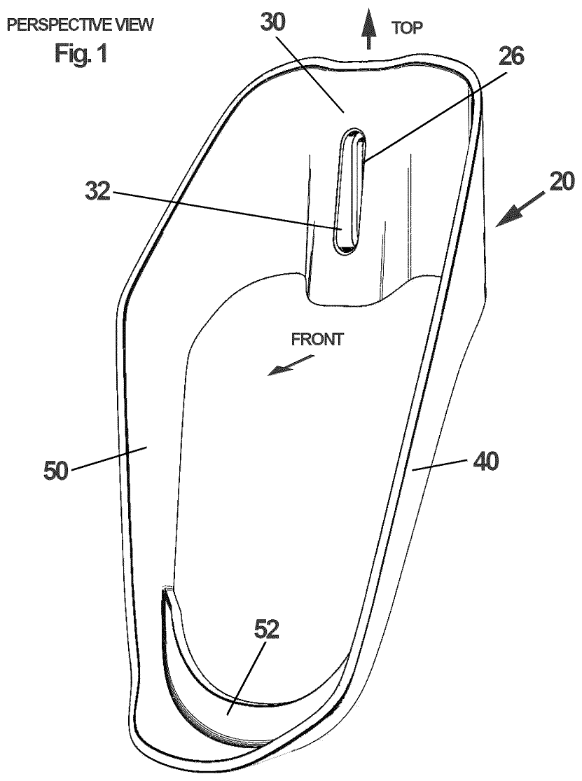

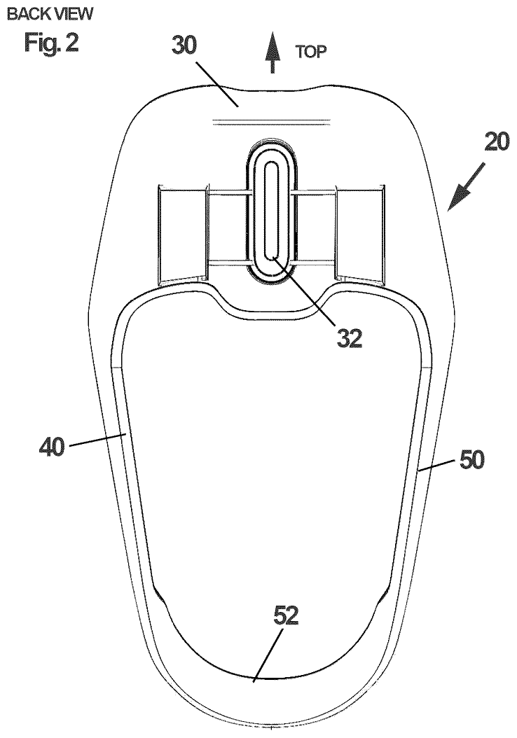

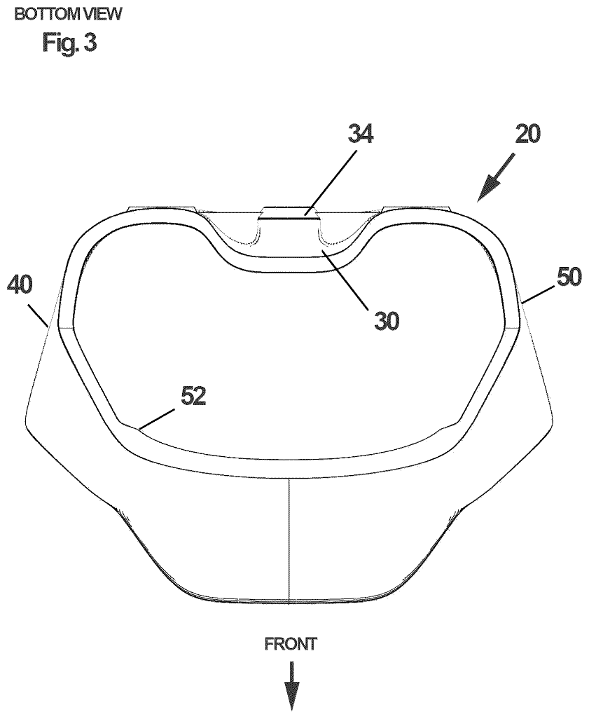

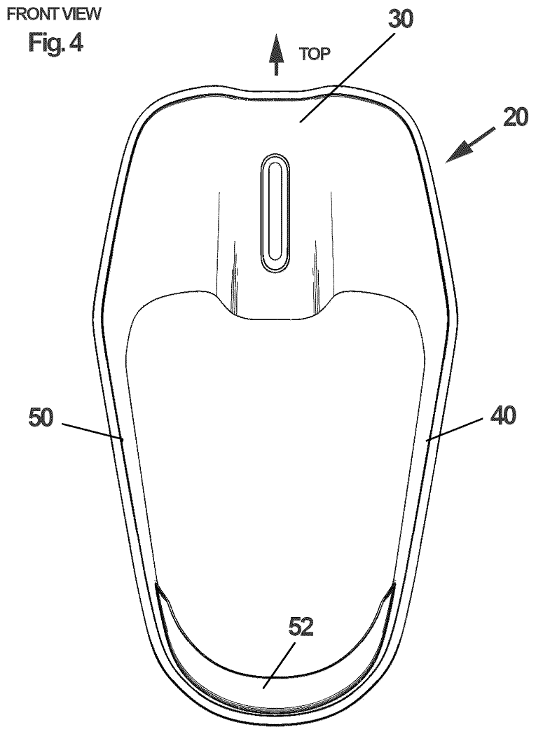

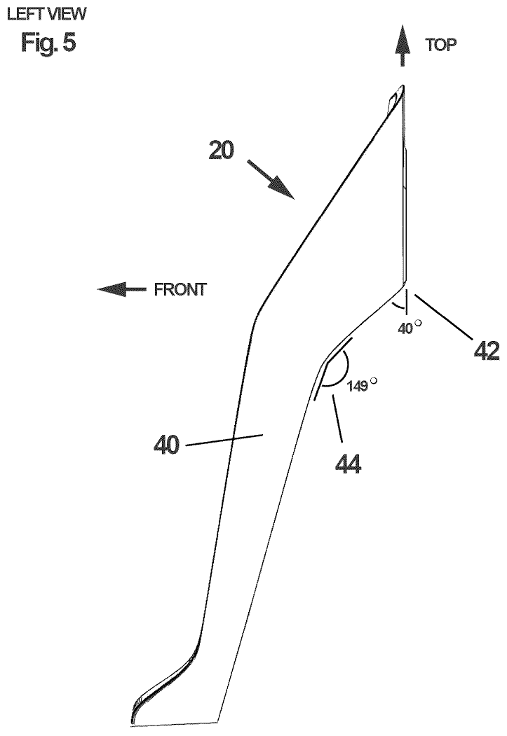

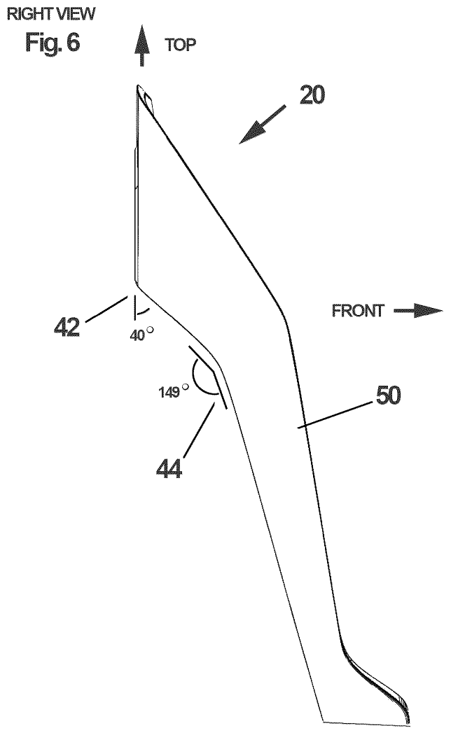

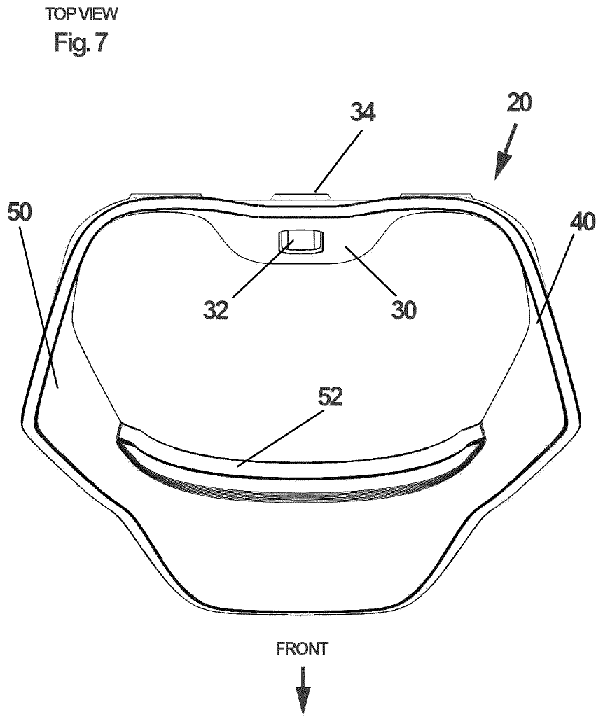

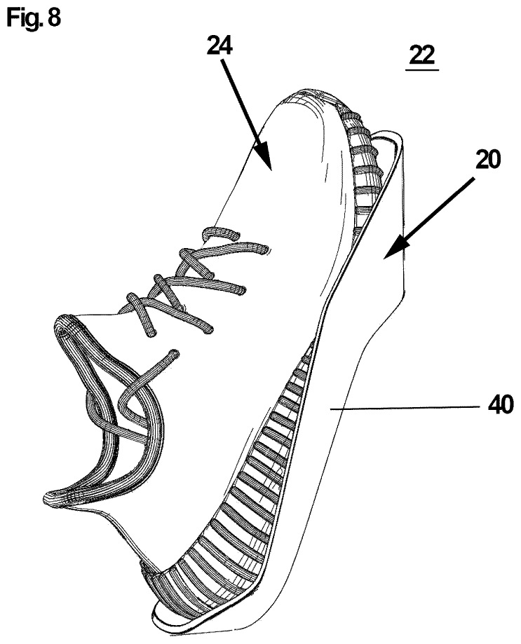

A first arm 40 extends from a first end of the base 30 at a first predetermined angle 42 with respect to the wall 22. It should be noted that the first predetermined angle 42 of the first portion of the first arm 40 in one contemplated embodiment is approximately forty-six degrees from the wall 22. A second portion of the first arm 40 extends from the first portion of the first arm 40 and includes a second predetermined included angle 44 of approximately one hundred and forty seven degrees. This second portion of the first arm 40 extends a predetermined distance until it forms a portion of the bottom of the shoe rack 20. The shoe rack 20 also includes a second arm 50 extending from a second end of the base 30 of the shoe rack 20 at the same forty-six degree angle for the first portion thereof and the same included angle of one hundred forty seven degrees for the second portion of the second arm 50 of the shoe rack 20. The base 30 of the shoe rack 20 has a predetermined length. The first portion of the first and second arm 40,50 of the shoe rack 20 also may include that same length, however the length of the shoe rack 20 may then reduce in a predetermined rate to a slightly smaller length for the first and second arm 40, 50 near the bottom portion of the shoe rack 20. The first and second arm 40, 50 meet at a bottom midpoint of the shoe rack 20. The shoe rack 20 generally forms an oval like shape or road bike seat shape for the shoe rack 20 when viewed from a front view. The bottom portion of the first and second arm 40, 50 generally have a predetermined curved shape that may mimic that of the outer heel and back portion of a shoe 24 to be arranged therein. It should be noted that the bottom portion of the first and second arm 40, 50 generally may increase in length at the very bottom portion in order to provide enough surface area to securely hold the back portion of the heel of the shoe 24 arranged in the shoe rack 20. It should be noted that it is contemplated that the shoe rack 20 of the embodiment of the present invention is designed for sneakers. Sneakers tend to be some of the most collected shoes and the shoe collection of sneakers may increase in value if displayed as art on the wall 22 of a room of a building, thus the shoe rack 20 as shown in FIGS. 1 through 8, generally is used for a sneaker, however any other type of men's shoe or women's shoe that does not have a high heel may also be used to be stored in the shoe rack 20 according to the present invention. It should be noted that a back surface of the base 30 may have at least one flat surface arranged thereon, but in the embodiment shown a first and second flat surface are arranged thereon. The first flat surface is arranged on one side of the slot 32 while the second flat surface is arranged another side of the slot 32. The flat surfaces may be any known shape and are used to receive one side of a double sided wall mount tape thereon in order to secure the shoe rack 20 to a wall in another contemplated embodiment.

The shoe rack 20 along the bottom surface thereof may also include a generally circumferential lip or flange 52 arranged at a back surface of the bottom portion of the first and second arm 40, 50 of the shoe rack 20. Each end of flange 52 may have a tapered angle surface. The flange 52 may extend a predetermined distance from an inside surface of the shoe rack 20, thus allowing for the bottom sole of the shoe 24 at the heel portion of the shoe 24 arranged therein to contact the circumferential lip 52 thus securing the shoe 24 in the shoe rack 20 due to the angle of the first and second arm 40, 50 of the shoe rack 20 with relation to the wall 22. It should further be noted that when the shoe 24 is stored in the shoe rack 20 the sole of the shoe 24 at the back heel portion may engage with the circumferential lip 52 of the shoe rack 20 while at or near the toe portion of the sole of the shoe 24 may engage with a surface of the base 30, thus holding the shoe 24 in proper position for display as an art piece on a wall 22 or surface of a room. The shoe rack 20 may be designed such that any size shoe from a small children's shoe to large men's shoes, may be displayed in the shoe rack 20. It is also contemplated that the shoe rack 20 may be made of any moldable plastic and that plastic may have any color, thus creating different design variations capable of being used for the display of the sneakers arranged therein. It should be noted that in the present invention a moldable plastic material is used for the shoe rack 20. However, it should be noted that any other type of soft plastic, hard plastic, composite, metal material, steel, or any other manmade or naturally occurring material may be used to form or mold the shoe rack 20 of the present invention. As shown in the drawings, the shoe rack 20 of the present invention which is designed to hold a single sneaker type shoe, is molded as a single piece. However, it should be noted that it may be molded as separate pieces and then connected to one another, either before to or after hanging on a wall 22 or surface whereon the display of the sneaker shoe 24 may occur. It should be noted that the first angle 42 and second angle 44 described above are approximations. It should be noted that the first angle 42 may be anywhere from five degrees to ninety degrees, depending on the design requirements of the shoe rack 20 and that the second included angle 44 may be anywhere from ninety degrees to one hundred eighty degrees as an included angle depending on the design requirements of the shoe rack 20. As described above the shoe rack 20 of the present invention is made to display a single sneaker. However, it is also contemplated that a shoe rack 20 having a spot for both a left and a right sneaker may be used to display the pair of sneakers in any known configuration. It is also contemplated that multiple shoe racks may be arranged on the wall or surface in any known pattern, such that the creative license of the shoe collector is the only limit as to how the shoes 24 may be represented and shown on the wall 22 of a building or room.

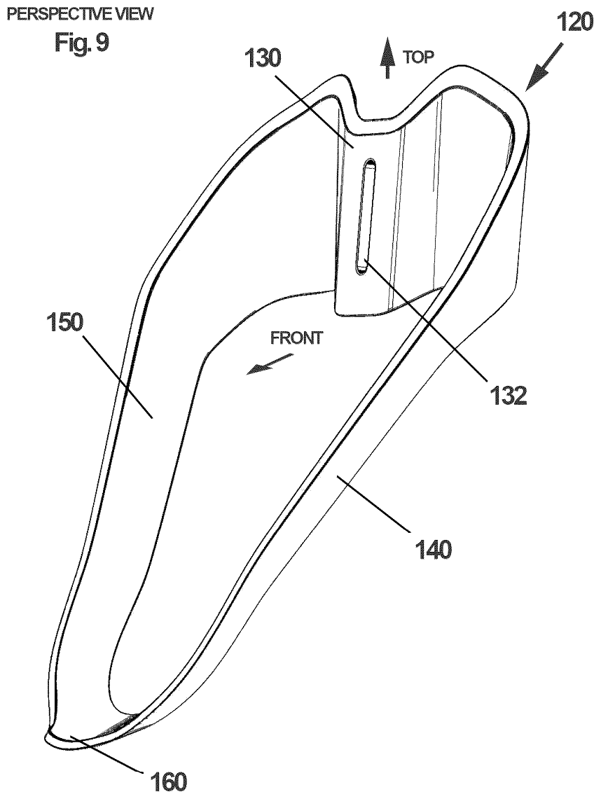

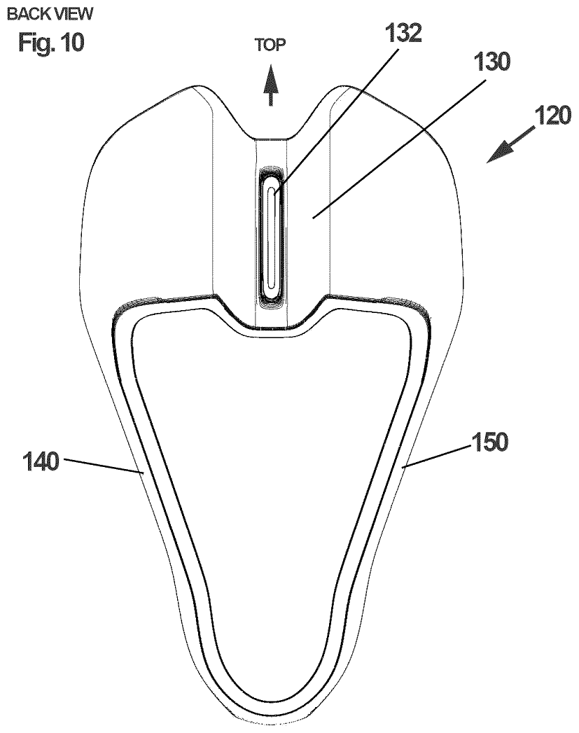

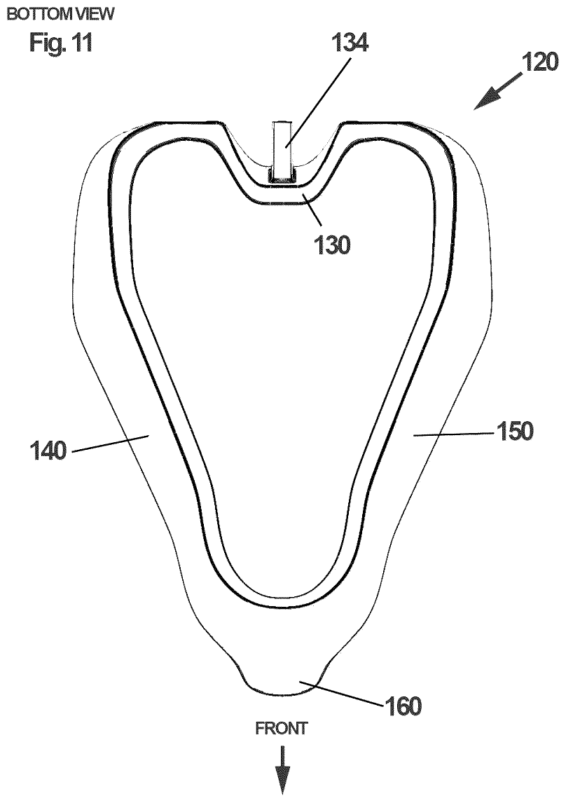

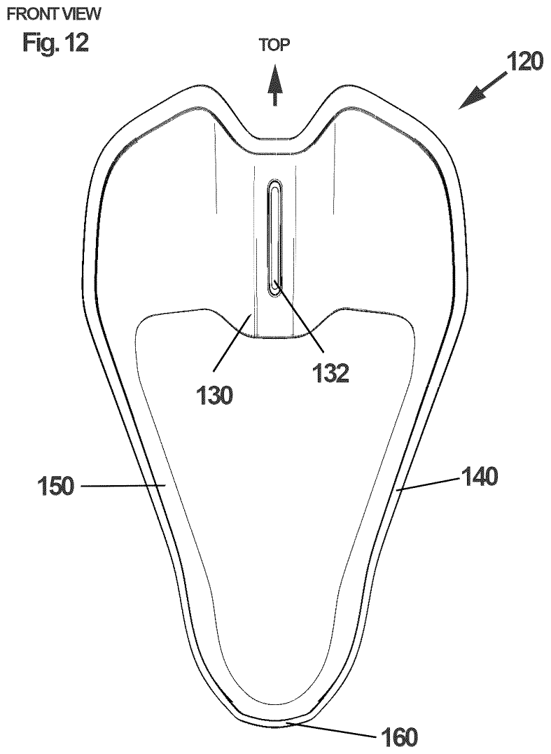

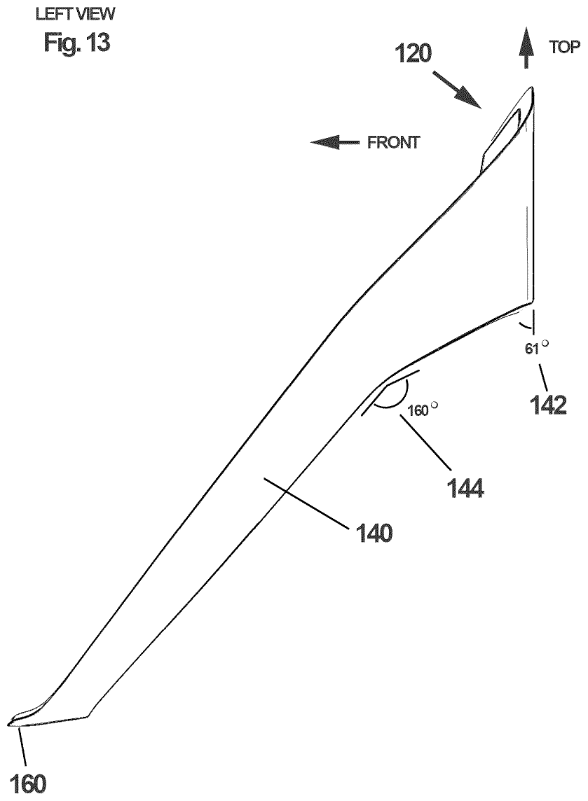

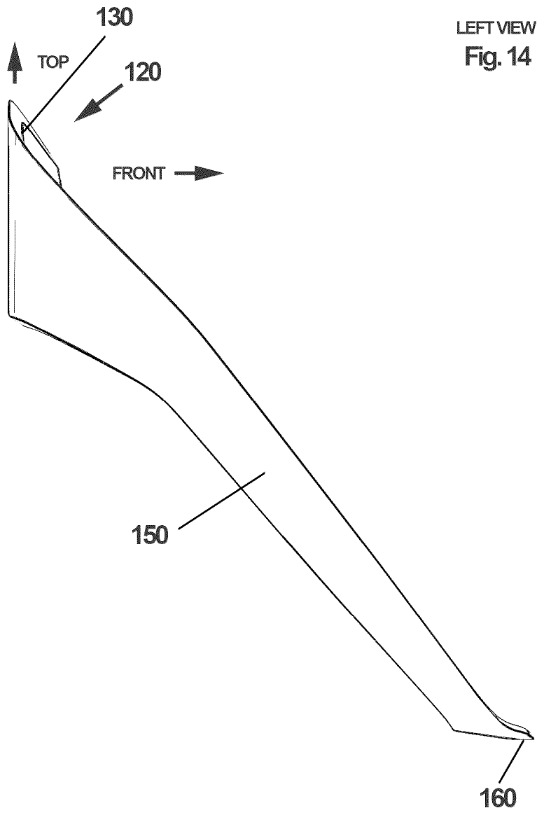

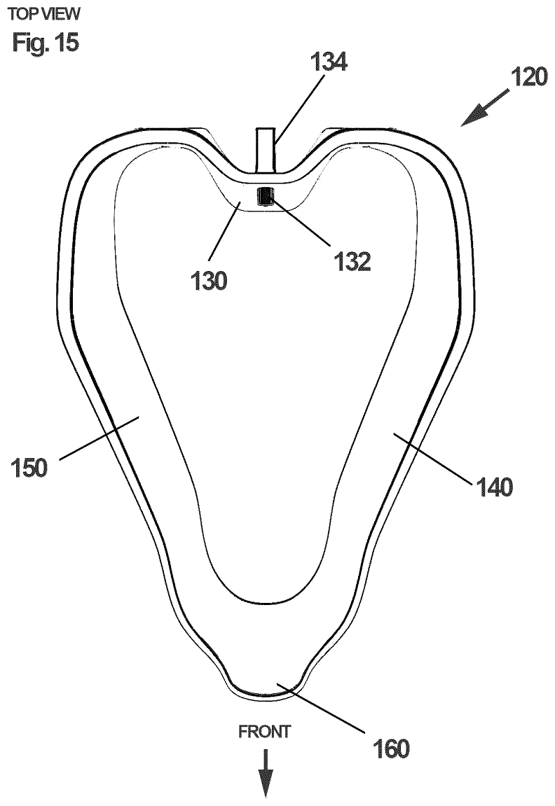

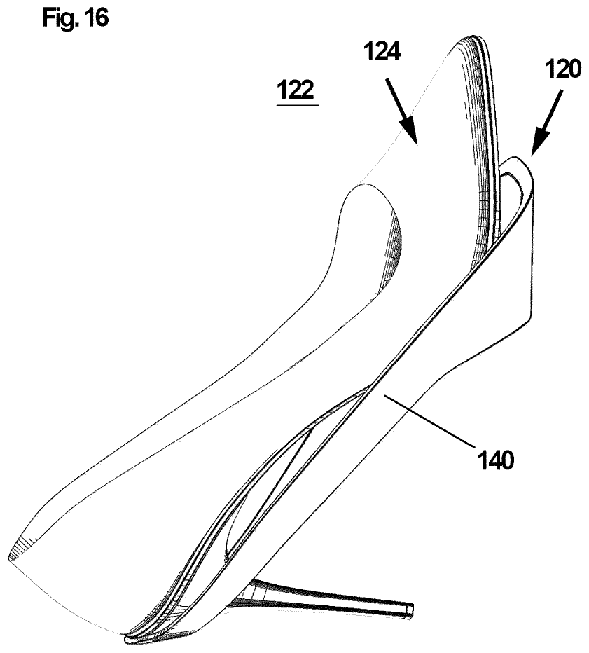

FIGS. 9 through 16 show an alternate embodiment of shoe rack 20 according to the present invention. Like numerals indicate like parts. Generally, the alternate embodiment of the shoe rack 120 is a shoe rack 120 that is capable of holding a high heel shoe 124 therein. The base 130 and the first and second arm 140, 150 are generally the same except the dimensions for such components for the high heel shoe rack 120 are different than those of the sneaker shoe rack 20. Generally, the first angle 142 in the high heel shoe rack 120 may be approximately sixty one degrees. The second angle 144 which is included of the high heel shoe rack 120, may be approximately one hundred sixty degrees. Therefore, the same ranges for the first angle 142 and the second angle 144 of the high heel alternate embodiment shoe rack 120 may be the same as those of the sneaker shoe rack 20 described above. It should be noted that the length of the base 130 of the high heel shoe rack 120 may also be different depending on the design requirements and the shoes to be arranged therein. The left arm and right arm 140, 150 of the high heel shoe rack 120 may taper in a reduced manner to the bottom portion of the shoe rack 120. It should be noted that the high heel shoe rack 120 may also in one contemplated embodiment be molded as a single moldable piece, however it is contemplated that it may be a multi piece shoe rack 120. Furthermore, the bottom portion of the high heel shoe rack 120 may include a flange 160 that extends towards the front of the bottom of the high heel shoe rack 120 thus allowing for better support of the back heel portion of the high heel shoe 124. The circumferential lip or half circular circumferential lip of the sneaker version of the shoe rack 20 does not occur on the high heel shoe rack 120 as the high heel of the shoe 124 may extend quite a distance from the bottom end of the shoe rack 120 towards the wall 122. Thus, the extended flange 160 extending from the front portion of the bottom edge of the high heel shoe rack 120 may help support the high heel shoe 124 when arranged in the shoe rack 120. Thus, the high heel shoe rack 120 may also allow for the display of the high heel shoes 124 owned by the high heel shoe collector in any manner desired or required by the high heel shoe collector. Thus, as shown in the alternate embodiment of the drawings, a single high heel shoe 124 may be able to be displayed in the shoe rack 120 of the present invention and a plurality of shoe racks 120 may be arranged on a wall 122 or surface of a room in any manner known to create an art display that may increase the value of the shoes 124 by arranging the shoes 124 in a more organized manner, thus increasing the buzz and positive good will of the shoe 124, hence increasing the value of the shoe 124. As described below, the shoe rack 120 of the present invention is for a single high heel shoe 124, however it is contemplated to make a dual shoe rack to hold both a left and right shoe in the form of a high heel shoe 124. It is also contemplated to have multiple or more than two shoe holder shoe racks formed and molded as one unit such that more than two shoes may also be displayed in one shoe rack 120 according to the present invention. It should be noted that a generally moldable plastic that may be made of any color is used for the high heel shoe rack 120, however any other material such as those described above for the sneaker shoe rack 20 may also be used. The high heel shoe rack 120 of the alternate embodiment according to the present invention generally has a heart shaped or bike seat shape when viewed from a front view thereof. It should be noted that any other shape of the arms and base of either the sneaker shoe rack 20 or the high heel shoe rack 120 may be used depending on the design requirements and the environment in which the shoe rack may be used.

Therefore, in operation, either the sneaker shoe rack 20 or the high heel shoe rack 120 may be attached to a wall 22 as either a single shoe rack 20 or with other single shoe racks 20 to have a cluster of a plurality of shoe racks 20 to create an artistic display of the shoes 24 in the shoe collection of the shoe owner. These shoe racks 20 are connected via any known fastener 26, such as a screw, nail, or any other known fastener that are passed through a slot or orifice 32 of the sneaker shoe rack 20 or the high heel shoe rack 120 into a wall 22 via any known wall fastening technique. It should be noted that generally a single fastener 26 is all that is needed to secure the shoe rack 20, however multiple fasteners may also be passed through the slot 32 to secure the shoe rack 20 to the wall 22 or surface in the room or building. The shoe rack 20 or shoe racks 20 are attached to the wall 22 with the top surface of the shoe rack 20 facing towards the ceiling. The high heel shoe 122 may be then placed sole first into the shoe racks 20 such that the sole of the high heel shoe 124 contacts a surface of the base 130 while the back portion of the shoe 124 contacts the bottom surface of the high heel shoe rack 120. A sneaker 24 may have a toe portion of the sole contact the base 30 of the sneaker shoe rack 20 while the back end of the sneaker may contact the bottom portion of the sneaker shoe rack 20 and the bottom sole of the sneaker may contact the circumferential flange 52 having a generally half circle shape arranged at a bottom portion of the sneaker shoe rack. These shoe racks 20 may be arranged in any known pattern or shape thus allowing for the sneakers and/or high heel shoes to be displayed for viewing by the public, thus increasing the value of the shoes via increased good will and increased social media hits to the shoes for other shoe collectors.

The present description is for illustrative purposes only and it should not be construed to limit the present invention in any way. Thus, a person skilled in the art will appreciate that various modifications might be made to the present and disclosed embodiments without departing from the scope and spirit of the present invention, which is defined in terms of the claims below. Other aspects, features and advantages may be apparent upon an examination of the attached drawing figures and appended claims.

What is claimed is:

1. A shoe rack for use on a wall or other surface, said shoe rack comprising:
a base;
a first arm extending from said base;
a second arm extending from said base; and
a bottom member arranged at an end of said first arm and at an end of said second arm.

2. The shoe rack of claim 1 wherein said base having a slot arranged at a general midpoint thereof.

3. The shoe rack of claim 2 wherein said base having a flange extending from a back surface thereof.

4. The shoe rack of claim 1 wherein said first arm having a first portion with a first predetermined angle, said first arm having a second portion with the second predetermined included angle.

5. The shoe rack of claim 4 wherein said first predetermined angle is approximately forty five degrees with respect to the wall, said second predetermined included angle is approximately one hundred and forty five degrees.

6. The shoe rack of claim 1 wherein said second arm having a first portion with a first predetermined angle, said second arm having a second portion with a second predetermined included angle.

7. The shoe rack of claim 6 wherein said first predetermined angle is approximately forty five degrees with respect to the wall, said second predetermined included angle is approximately one hundred and forty five degrees.

8. The shoe rack of claim 1 wherein said bottom member having a predetermined curved shape that mimics the outer heel or back of a shoe.

9. The shoe rack of claim 1 wherein said bottom member having a circumferential flange arranged at a back surface thereof.

10. The shoe rack of claim 4 wherein said first predetermined angle is approximately sixty degrees with respect to the wall, said second predetermined included angle is approximately one hundred and sixty degrees.

11. The shoe rack of claim 6 wherein the first predetermined angle is approximately sixty degrees with respect to the wall, and said second predetermined included angle is approximately one hundred and sixty degrees.

12. The shoe rack of claim 1 further including a flange extending from a front portion of said bottom member.

13. The shoe rack of claim 1 wherein said base, said first arm, said second arm, and said bottom member are capable of holding and displaying a single shoe.

14. A method of storing and displaying a shoe on a wall or a surface of a structure, said method comprising the steps of:
securing a shoe rack to the wall in a predetermined position;
placing a single shoe in said shoe rack, said single shoe arranged in said shoe rack with a heel and a toe of said single shoe arranged in a generally vertical plane; and
said single shoe having said toe arranged above said heel of said single shoe.

15. The method of claim 14 further comprising the step of securing a second shoe rack to the wall at a second predetermined position.

16. The method of claim 14 wherein said step of securing uses a fastener to connect said shoe rack to the wall.

17. The method of claim 14 wherein said shoe rack comprises a base, a first arm extending from a first end of said base, a second arm extending from a second end of said base, and a bottom member arranged at a bottom portion of said first arm and said second arm.

18. The method of claim 17 wherein said base having a slot arranged therethrough, said slot receives a fastener therethrough to secure said shoe rack to the wall.

19. The method of claim 14 wherein said single shoe is a sneaker or a high heel shoe.

20. The method of claim 14 wherein a plurality of shoe racks may be arranged on the wall at predetermined positions to create art work while displaying a plurality of shoes.
